(19) United States
(12) Patent Application Publication
(10) Pub. No.: US 2026/0030648 A1
(43) Pub. Date: Jan. 29, 2026

(54) INFORMATION PROCESSING METHOD AND COMPUTER

(71) Applicant: OBAYASHI CORPORATION, Tokyo (JP)

(72) Inventors: Akinori TSUNAWAKI, Tokyo (JP); Riki TABATA, Tokyo (JP)

(73) Assignee: OBAYASHI CORPORATION, Tokyo (JP)

(21) Appl. No.: 18/997,962

(22) PCT Filed: Aug. 28, 2023
(86) PCT No.: PCT/JP2023/030857

§ 371 Date: Oct. 13, 2025

(30) Foreign Application Priority Data
Aug. 29, 2022 (JP) 2022-135479

(51) Int. Cl. G06Q 30/0202; G06Q 10/0631

(52) U.S. Cl. CPC G06Q 30/02022; G06Q 10/06313

(57) ABSTRACT

A program that causes a computer to function as reception means, storage means, and first determination means. The reception means receives real estate information which is information on real estate as a candidate at which a data center should be provided in a data storage system composed of a plurality of data centers coordinated with each other. The first determination means determines whether or not the data center should be provided at the real estate corresponding to the real estate information received by the reception means, based on the real estate information received by the reception means and determination criterion information stored in a storage unit by the storage means in advance.

### TECHNICAL FIELD

The present disclosure relates to an information processing method and a computer.

### BACKGROUND ART

As dedicated buildings for storing servers and network devices, data centers are provided at various locations. Conventionally, to enhance safety of such data centers, efforts for enhancing safety of device equipment such as a vibration isolation device, an electric generator, and an uninterruptible power supply are being performed. As a building for such a data center, Japanese Laid-Open Patent Publication No. 2011-12407 (JP2011-12407A) discloses a configuration that enables multiple units to be safely placed even in a case where there is only a limited site.

### SUMMARY OF THE INVENTION

Even if safety of device equipment such as a vibration isolation device, an electric generator, and an uninterruptible power supply is enhanced for enhancing safety of the data center as described above, there is a problem that a safety rate in the entire data storage system does not become high in a case where a safety rate of a computer such as a server composing the data center is low. Accordingly, the inventors of the present application have found that a safety rate in the entire data storage system is enhanced by combining a plurality of data centers coordinated with each other. Here, in a case of newly providing a data center for composing the data storage system, it is convenient to know whether or not such provision of the data center is appropriate.

The present disclosure has been made in view of the above circumstances and an object of the present disclosure is to provide an information processing method and a computer that, in a case of newly providing a data center for composing a data storage system, can determine whether or not such provision of the data center is appropriate.

An information processing method of the present disclosure is an information processing method performed by a computer executing a program, the method including: receiving real estate information which is information on real estate as a candidate at which a data center should be provided in a data storage system composed of a plurality of data centers coordinated with each other; storing determination criterion information serving as a determination criterion for provision of the data center, in a storage unit in advance; and determining whether or not the data center should be provided at the real estate corresponding to the received real estate information, based on the received real estate information and the determination criterion information stored in the storage unit in advance.

The information processing method of the present disclosure may include calculating a profitability in a case of providing the data center at the real estate, and in determining whether or not the data center should be provided at the real estate corresponding to the received real estate information, whether or not the data center should be provided at the real estate corresponding to the received real estate information may be determined based on the profitability.

In the information processing method of the present disclosure, in determining whether or not the data center should be provided at the real estate corresponding to the received real estate information, the profitability may be calculated, based on the received real estate information, for each category of at least any of a category regarding whether a building at which the data center is to be provided is newly constructed or renovated, a category of a specification level of the data center, or a category in which whether the building at which the data center is to be provided is newly constructed or renovated and the specification level of the data center are combined, and whether or not the data center should be provided at the real estate corresponding to the received real estate information may be determined for each category.

In the information processing method of the present disclosure, if the profitability in the case of providing the data center is smaller than a predetermined threshold for all of a plurality of the categories, it may be determined that the data center should not be provided at the real estate corresponding to the received real estate information, and if the profitability in the case of providing the data center is equal to or greater than the predetermined threshold for at least one of the plurality of categories, it may be determined that the data center should be provided at the real estate corresponding to the received real estate information.

The information processing method of the present disclosure may include determining which category is appropriate, based on the calculated profitability for each category.

The information processing method of the present disclosure may include: storing information on the data center already provided in the data storage system, in the storage unit in advance; and calculating a safety rate of the data storage system in a case of providing the data center at the real estate, based on the received real estate information and the information on the data center stored in the storage unit in advance.

The information processing method of the present disclosure may include calculating a profitability in the case of providing the data center at the real estate, and in determining whether or not the data center should be provided at the real estate corresponding to the received real estate information, whether or not the data center should be provided at the real estate corresponding to the received real estate information may be determined based on the calculated profitability and the calculated safety rate.

The information processing method of the present disclosure may include: calculating the profitability and the safety rate, based on the received real estate information, for each category of at least any of a category regarding whether a building at which the data center is to be provided is newly constructed or renovated, a category of a specification level of the data center, or a category in which whether the building at which the data center is to be provided is newly constructed or renovated and the specification level of the data center are combined; and determining whether or not the data center should be provided at the real estate corresponding to the received real estate information, for each category.

The information processing method of the present disclosure may include determining which category is appropriate, based on the calculated profitability and the calculated safety rate for each category.

In the information processing method of the present disclosure, in a case where it is determined that the data center should be provided at the real estate corresponding to the received real estate information, if information indicating that the data center is to be provided at the real estate is received, information on the data center may be stored in the storage unit.

An information processing method of the present disclosure is an information processing method performed by a computer executing a program, the method including: receiving real estate information which is information on real estate as a candidate at which a data center should be provided in a data storage system composed of a plurality of data centers coordinated with each other; calculating a profitability of the data storage system in a case of providing the data center at the real estate; and determining whether or not the data center should be provided at the real estate corresponding to the real estate information, based on the calculated profitability.

A computer of the present disclosure is configured to, by executing a program: receive real estate information which is information on real estate as a candidate at which a data center should be provided in a data storage system composed of a plurality of data centers coordinated with each other; store determination criterion information serving as a determination criterion for provision of the data center, in a storage unit in advance; and determine whether or not the data center should be provided at the real estate corresponding to the received real estate information, based on the received real estate information and the determination criterion information stored in the storage unit in advance.

The computer of the present disclosure may be configured to, by executing the program, calculate a profitability in a case of providing the data center at the real estate, and in determining whether or not the data center should be provided at the real estate corresponding to the received real estate information, whether or not the data center should be provided at the real estate corresponding to the received real estate information may be determined based on the profitability.

In the computer of the present disclosure, in determining whether or not the data center should be provided at the real estate corresponding to the received real estate information, the profitability may be calculated, based on the received real estate information, for each category of at least any of a category regarding whether a building at which the data center is to be provided is newly constructed or renovated, a category of a specification level of the data center, or a category in which whether the building at which the data center is to be provided is newly constructed or renovated and the specification level of the data center are combined, and whether or not the data center should be provided at the real estate corresponding to the received real estate information may be determined for each category.

The computer of the present disclosure may be configured to, by executing the program, determine which category is appropriate, based on the calculated profitability for each category.

The computer of the present disclosure may be configured to, by executing the program: store information on the data center already provided in the data storage system, in the storage unit in advance; and calculate a safety rate of the data storage system in a case of providing the data center at the real estate, based on the received real estate information and the information on the data center stored in the storage unit in advance.

The computer of the present disclosure may be configured to, by executing the program, calculate a profitability in the case of providing the data center at the real estate, and in determining whether or not the data center should be provided at the real estate corresponding to the received real estate information, whether or not the data center should be provided at the real estate corresponding to the received real estate information may be determined based on the calculated profitability and the calculated safety rate.

The computer of the present disclosure may be configured to, by executing the program: calculate the profitability and the safety rate, based on the received real estate information, for each category of at least any of a category regarding whether a building at which the data center is to be provided is newly constructed or renovated, a category of a specification level of the data center, or a category in which whether the building at which the data center is to be provided is newly constructed or renovated and the specification level of the data center are combined; and determine whether or not the data center should be provided at the real estate corresponding to the received real estate information, for each category.

The computer of the present disclosure may be configured to, by executing the program, determine which category is appropriate, based on the calculated profitability and the calculated safety rate for each category.

In the computer of the present disclosure, in a case where it is determined that the data center should be provided at the real estate corresponding to the received real estate information, if information indicating that the data center is to be provided at the real estate is received, information on the data center may be stored in the storage unit.

### BRIEF DESCRIPTION OF THE DRAWINGS

FIG. 1 schematically shows a configuration of a data storage system according to an embodiment of the present disclosure.

FIG. 2 schematically shows a configuration of each data center composing the data storage system shown in FIG. 1.

FIG. 3 schematically shows a configuration of a computer (server) according to the embodiment of the present disclosure.

FIG. 4 is a flowchart showing operation when, in a case of newly providing a data center for composing the data storage system, the computer shown in FIG. 3 determines whether or not such provision of the data center is appropriate.

FIG. 5 shows a calculation formula for the safety rate of the data storage system.

FIG. 6 is a flowchart showing another operation when, in a case of newly providing a data center for composing the data storage system, the computer shown in FIG. 3 determines whether or not such provision of the data center is appropriate.

### DESCRIPTION OF THE PREFERRED EMBODIMENTS

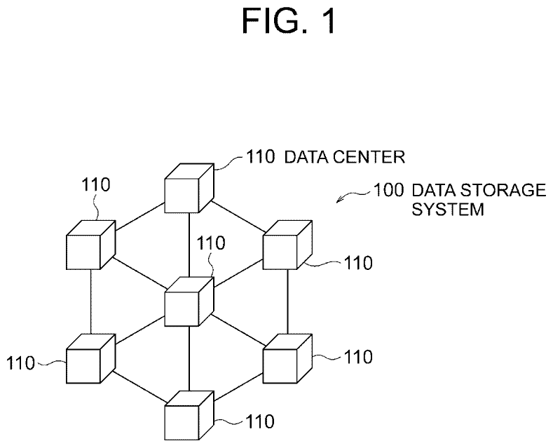

Hereinafter, an embodiment of the present disclosure will be described with reference to the drawings. FIG. 1 to FIG. 5 show a computer 10 and an information processing method by the computer 10 according to the present embodiment.

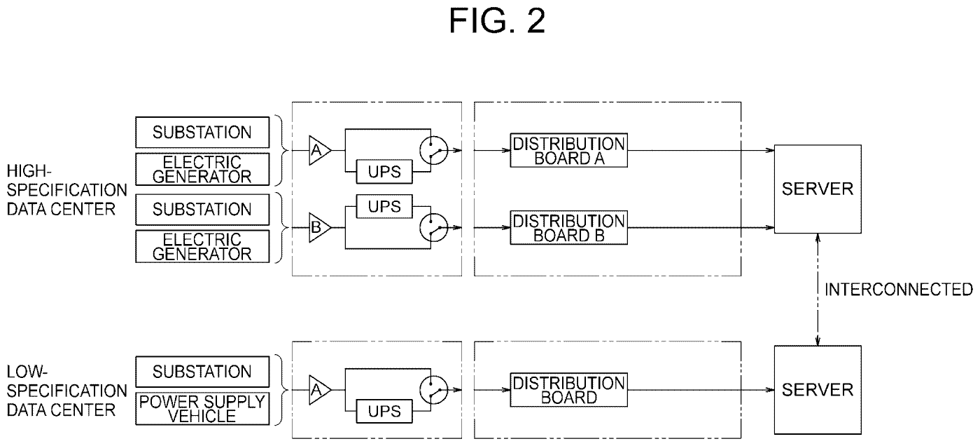

First, a data storage system 100 and a plurality of data centers 110 composing the data storage system 100 will be described with reference to FIG. 1 and FIG. 2. In the present embodiment, the data centers 110 for storing servers and network devices are provided at various locations, and the plurality of data centers 110 are combined to compose the data storage system 100. As shown in FIG. 1, the servers provided at the respective data centers 110 are connected communicably with each other via optical lines, for example. By connecting the servers of the data centers 110 to each other as described above, the data storage system 100 is constructed as a virtual large-scale data center group. In the data storage system 100, even in a case where a trouble has occurred in the server of one data center 110, if there are no malfunctions in the servers of the other data centers 110, the entire data storage system 100 can perform operation without any problems, using information stored in the servers of the other data centers 110. In such operation of the data storage system 100, data may be stored in the plurality of data centers 110 in a distributed manner, or the same data may be stored in each data center 110 so that the data center 110 is used as a backup.

As shown in FIG. 2, the data centers 110 composing the data storage system 100 include a high-specification data center and a low-specification data center. The high-specification data center 110 is supplied with power from a plurality of power supplies such as a substation and an electric generator, and is provided with a plurality of power supply paths including uninterruptible power supplies (UPS), in parallel, and a distribution board is provided at each power supply path. Thus, in the high-specification data center 110, power is supplied to the server from a plurality of power supply paths, and therefore, although a safety rate of the data center 110 (a probability that no trouble will occur in the entire data center 110 during a predetermined period) becomes high, the provision cost and the operating cost increase.

On the other hand, the low-specification data center 110 is supplied with power from a single power supply such as a substation or a power supply vehicle, and is provided with a single power supply path including an uninterruptible power supply (UPS), and a distribution board is provided at the single power supply path. Thus, in the low-specification data center 110, power is supplied to the server from the single power supply path, and therefore, although the safety rate of the data center 110 becomes smaller as compared to the high-specification data center 110, the provision cost and the operating cost decrease.

In the present embodiment, the servers of the high-specification data centers 110 are connected communicably with each other, the servers of the low-specification data centers 110 are connected communicably with each other, and/or the server of the high-specification data center 110 and the server of the low-specification data center 110 are connected communicably with each other, whereby the data storage system 100 is constructed.

Conventionally, to enhance safety of the data center 110, efforts for enhancing safety of device equipment such as a vibration isolation device, an electric generator, and an uninterruptible power supply are being performed. However, even if safety of device equipment such as a vibration isolation device, an electric generator, and an uninterruptible power supply is enhanced, there is a problem that a safety rate in the entire data storage system 100 (a probability that no trouble will occur in the entire data storage system 100 during a predetermined period) does not become high in a case where a safety rate of the computer such as the server composing the data center 110 (a probability that a trouble in which, for example, the computer such as the server becomes unusable, will not occur during a predetermined period) is low. Therefore, the inventors of the present application have found that the safety rate in the entire data storage system 100 is enhanced by combining a plurality of data centers 110 coordinated with each other.

When real estate information which is information on real estate as a candidate at which the data center 110 should be provided is inputted, the computer 10 according to the present embodiment determines whether or not the data center 110 should be provided at the real estate.

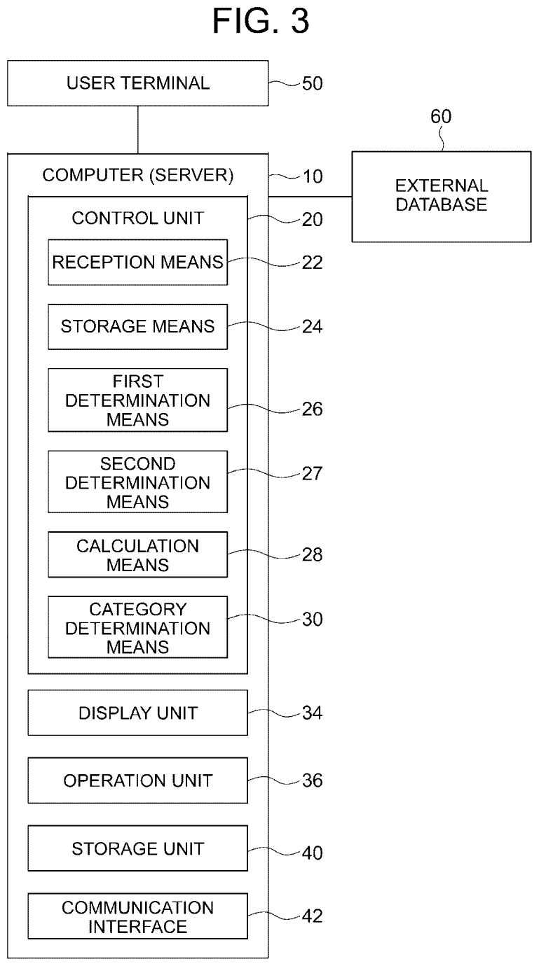

A configuration of the computer 10 according to the present embodiment will be described with reference to FIG. 3. The computer 10 includes a control unit 20, a display unit 34, an operation unit 36, a storage unit 40 (non-transitory tangible medium), and a communication interface 42. The details of components of the computer 10 will be described below.

The control unit 20 is, for example, a central processing unit (CPU) or the like, and executes a program stored in the storage unit 40, to function as reception means 22, storage means 24, first determination means 26, second determination means 27, calculation means 28, and category determination means 30. The reception means 22 receives various kinds of information from an external device (e.g., a user terminal 50 or an external database 60). In the present embodiment, the reception means 22 receives real estate information (described later) from the user terminal 50, or receives determination criterion information (described later), use district information (described later), local government information (described later), and information on the already provided data center 110 (described later) from the external data base 60. The details of the information received by the reception means 22 will be described later. The storage means 24 stores the determination criterion information (described later) serving as a determination criterion for provision of the data center 110 and the information on the already provided data center 110 in the data storage system 100, in the storage unit 40, the external database 60, or the like, in advance. The first determination means 26 determines whether or not the data center 110 should be provided at the real estate corresponding to the real estate information received by the reception means 22, based on the real estate information received by the reception means 22 and the determination criterion information stored in the storage unit 40 or the external database 60 in advance. The second determination means 27 determines whether or not the data center 110 should be provided at the real estate corresponding to the real estate information received by the reception means 22, based on a profitability (described later) in a case of providing the data center 110 at the real estate. The details of the determination methods by the first determination means 26 and the second determination means 27 will be described later. Based on the real estate information received by the reception means 22, the calculation means 28 calculates the profitability and the safety rate of the data storage system 100 in a case of providing the data center 110 at the real estate corresponding to the real estate information. The details of the calculation methods for the profitability and the safety rate by the calculation means 28 will be described later. The category determination means 30 determines which category is appropriate, based on the profitability for each category calculated by the calculation means 28 or the profitability and the safety rate for each category calculated by the calculation means 28. The details of the determination method by the category determination means 30 will be described later.

The program executed by the control unit 20 is not limited to the one stored in the storage unit 40. As the program executed by the control unit 20, for example, a program transmitted from an external device to the control unit 20 via the communication interface 42, a program stored in a storage medium such as a USB memory mounted to the computer 10, or a program stored in a server (e.g., a cloud server) or the like separate from the computer 10, may be used.

The display unit 34 is formed of, for example, a monitor or the like, and displays various kinds of information by receiving a display instruction signal from the control unit 20. The operation unit 36 is formed of, for example, a keyboard, a mouse, and the like, and an operator can input various kinds of information to the control unit 20 through the operation unit 36. In the present embodiment, a touch panel or the like may be used as a unit in which the display unit 34 and the operation unit 36 are integrated. The storage unit 40 is a non-transitory tangible medium. Specifically, the storage unit 40 is formed of, for example, a hard disk drive (HDD), a random access memory (RAM), a read only memory (ROM), a solid state drive (SSD), and the like, and allows various kinds of information to be stored in the storage unit 40.

The communication interface 42 is for connecting the control unit 20 communicably with an external device (e.g., the user terminal 50 or the external database 60). The control unit 20 can perform transmission/reception of signals to/from an external device (e.g., the user terminal 50 or the external database 60) via the communication interface 42.

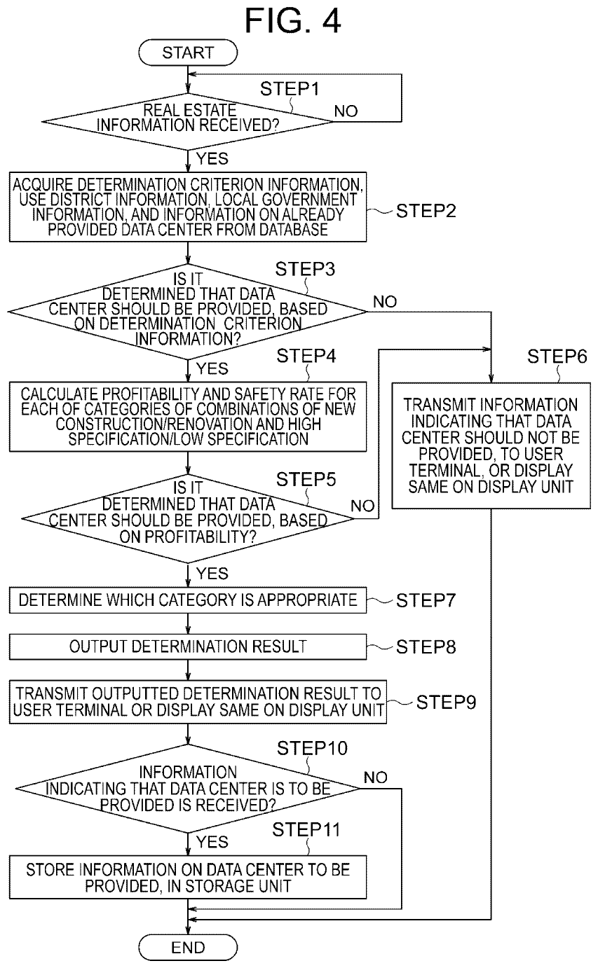

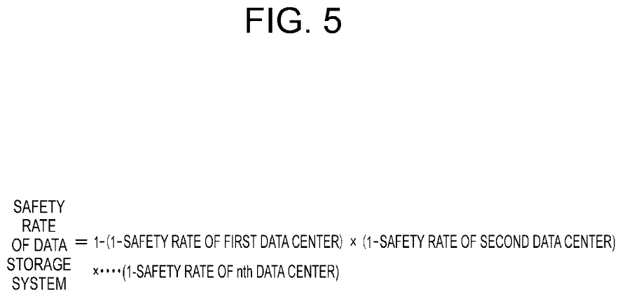

Next, the information processing method by the computer 10 will be described with reference to FIG. 4 and FIG. 5. FIG. 4 is a flowchart showing operation when, in a case of newly providing the data center 110 for composing the data storage system 100, the computer 10 shown in FIG. 3 determines whether or not such provision of the data center 110 is appropriate. FIG. 5 shows a calculation formula for the safety rate of the data storage system 100.

In a case where a user desires to add a new data center 110 to the data storage system 100 composed of a plurality of already provided data centers 110, the user might desire to confirm whether or not there is a problem in newly constructing or renovating a provision place of the data center 110 at a building. In this case, the user inputs real estate information which is information on real estate as a candidate at which the data center 110 should be newly provided, through the user terminal 50. The real estate information includes at least one kind of information among information on an owner of the real estate, address information, the building age, the number of stories, the floor height, the earthquake resistance, the building use, the floor load capacity, the total floor area, and the room vacancy state of the building at which the data center 110 is to be provided, information regarding whether or not the site is a vacant lot, and the like. The real estate information inputted to the user terminal 50 is transmitted from the user terminal 50 to the computer 10. Thus, the reception means 22 receives the real estate information. Instead of the user inputting the real estate information to the user terminal 50, the user may input the real estate information directly to the control unit 20 of the computer 10 by the operation unit 36 of the computer 10. Also in this case, the reception means 22 receives the real estate information inputted through the operation unit 36.

When the reception means 22 receives the real estate information (“YES” in STEP1 in FIG. 4), the control unit 20 acquires the determination criterion information, the use district information, the local government information, and the information on the already provided data center 110 from the storage unit 40 or the external database 60 (STEP2 in FIG. 4). Specifically, an information acquisition command is transmitted from the control unit 20 to the external database 60, whereby the determination criterion information, the use district information, the local government information, and the information on the already provided data center 110 are transmitted from the external database 60 to the control unit 20. Alternatively, the control unit 20 reads the determination criterion information, the use district information, the local government information, and the information on the already provided data center 110 from the storage unit 40.

The determination criterion information stored in the storage unit 40 or the external database 60 includes a plurality of criteria, e.g., that the age of the building at which the data center 110 is to be provided is equal to or smaller than a predetermined number of years, that the earthquake resistance of the building at which the data center 110 is to be provided complies with new earthquake resistance standards, that the room vacancy state of the building at which the data center 110 is to be provided indicates presence of vacant rooms on a plurality of floors, that the floor height of the building at which the data center 110 is to be provided is greater than a predetermined length, that the building use of the building at which the data center 110 is to be provided is other than a residence, a multiple dwelling unit, and a hotel, and that the total floor area of the building at which the data center 110 is to be provided is equal to or greater than a predetermined value. The use district information stored in the storage unit 40 or the external database 60 includes information about the use of the real estate, i.e., category 2 residential, quasi-residential, neighborhood commercial, commercial, quasi-industrial, or industrial.

The local government information stored in the storage unit 40 or the external database 60 includes hazard information at the address of the real estate in the real estate information received by the reception means 22 (specifically, hazard information on at least one of storm surge, flood, inland flooding, earthquake, and sediment disaster). The information on the already provided data center 110 includes the specification level of the already provided data center 110 (specifically, high specification or low specification), the position of the already provided data center 110, information on the building at which the data center 110 is provided (specifically, the building age, the number of stories, the floor height, the earthquake resistance, the building use, the total floor area, and the room vacancy state of the building at which the data center 110 is already provided, etc.).

Next, the first determination means 26 determines whether or not the data center 110 should be provided at the real estate corresponding to the real estate information received by the reception means 22, based on the real estate information received by the reception means 22 and the determination criterion information stored in the storage unit 40 or the external database 60 by the storage means 24 in advance. Specifically, the first determination means 26 determines whether or not the data center 110 should be provided, based on whether or not a plurality of criteria in the determination criterion information stored in the storage unit 40 or the external database 60 are satisfied based on the real estate information received by the reception means 22. Specifically, the first determination means 26 may determine that the data center 110 should be provided only in a case where the plurality of criteria are all satisfied, or as another configuration, the first determination means 26 may determine that the data center 110 should be provided in a case where a predetermined number of criteria among the plurality of criteria are satisfied. As another example, scoring may be performed for each criterion, and the first determination means 26 may determine whether or not the data center 110 should be provided, based on the total number of score points. Specifically, if the total number of score points for the respective criteria is equal to or greater than a predetermined threshold, the first determination means 26 may determine that the data center 110 should be provided. Even in a case where the first determination means 26 performs determination using such scoring, if the real estate information received by the reception means 22 does not satisfy a predetermined criterion, the first determination means 26 may determine that the data center 110 should not be provided. The determination method by the first determination means 26 is not limited to the above method, and various other methods may be used.

Even in a case where it is determined that the data center 110 should be provided at the real estate corresponding to the real estate information received by the reception means 22, based on the real estate information received by the reception means 22 and the determination criterion information stored in the storage unit 40 and the external database 60 in advance by the storage means 24 (“YES” in STEP3 in FIG. 4), if the profitability in a case of providing the new data center 110 is low, the second determination means 27 determines that the data center 110 should not be provided at the real estate corresponding to the real estate information received by the reception means 22. To describe in more detail, the calculation means 28 calculates the profitability and the safety rate of the data storage system 100 in a case of providing the data center 110 in each of categories of combinations of new construction/renovation and high specification/low specification (STEP4 in FIG. 4). Specifically, the calculation means 28 calculates the profitability and the safety rate of the data storage system 100 in each of categories, i.e., when a building at which the data center 110 is to be provided is newly constructed and the high-specification data center 110 is provided, when a building at which the data center 110 is to be provided is newly constructed and the low-specification data center 110 is provided, when a building at which the data center 110 is to be provided is renovated and the high-specification data center 110 is provided, and when a building at which the data center 110 is to be provided is renovated and the low-specification data center 110 is provided. As described above, the safety rate of the low-specification data center 110 is smaller than that of the high-specification data center 110, but the provision cost and the operating cost for the low-specification data center 110 are lower than those for the high-specification data center 110.

To describe in more detail, the calculation means 28 calculates the profitability as a new criterion by dividing the increase amount of profit per unit period (e.g., the increase amount of profit during a year) when the new data center 110 is provided by a construction cost for providing the new data center 110. Specifically, a manager of the data storage system 100 charges a user of the service for a cost, based on a data processing amount, an electricity usage amount, an electricity contract amount, and the like of each data center 110, and the charged amount is income for the manager of the data storage system 100. Here, the data processing amount of each data center 110 is often substantially proportional to the actual electricity usage amount. In addition, the manager of the data storage system 100 pays an electric company an electricity charge in accordance with the electricity usage amount, the electricity contract amount, and the like of each data center 110. Therefore, profit obtained by subtracting expenditure from income on the data storage system 100 has a high correlation with the electricity usage amount, the electricity contract amount, and the like of each data center 110. In addition, the construction cost for providing the data center 110 depends on the scale of the data center 110, and the scale of the data center 110 has a correlation with the electricity usage amount, the electricity contract amount, and the like of each data center 110. Therefore, the profitability calculated by the calculation means 28 has a correlation with the electricity usage amount, the electricity contract amount, and the like of each data center 110. In addition, the calculation means 28 calculates the safety rate of the data storage system 100, based on the safety rates of the data centers 110. Specifically, as shown by the formula in FIG. 5, for example, in a case where n data centers 110 from a first data center 110 to an nth data center 110 are to be provided, values obtained by respectively subtracting the safety rates of the data centers 110 from 1 are multiplied and then the resultant value is subtracted from 1, to calculate the safety rate of the data storage system 100. As described above, even in a case where a trouble has occurred in the server of one data center 110, if there are no malfunctions in the servers of the other data centers 110, the entire data storage system 100 can perform operation without any problems, using information stored in the servers of the other data centers 110. Therefore, as the number of the data centers 110 composing the data storage system 100 increases, the safety rate of the data storage system 100 becomes greater. However, if the number of the data centers 110 composing the data storage system 100 is excessively increased, the provision cost and the operating cost become high.

If the profitability in a case of providing the data center 110 is smaller than a predetermined threshold for all of the plurality of categories described above, the second determination means 27 determines that the data center 110 should not be provided at the real estate corresponding to the real estate information received by the reception means 22 (“NO” in STEP5 in FIG. 4). On the other hand, if the profitability in a case of providing the data center 110 is equal to or greater than the predetermined threshold for at least one of the plurality of categories described above, the second determination means 27 determines that the data center 110 should be provided at the real estate corresponding to the real estate information received by the reception means 22 (“YES” in STEP5 in FIG. 4).

If the first determination means 26 or the second determination means 27 determines that the data center 110 should not be provided at the real estate corresponding to the real estate information received by the reception means 22 (“NO” in STEP3 or “NO” in STEP5 in FIG. 4), the control unit 20 outputs information indicating that the data center 110 should not be provided. The outputted information is transmitted to the user terminal 50 or displayed on the display unit 34 (STEP6 in FIG. 4). Thus, a user can recognize that the data center 110 should not be provided at the real estate corresponding to the real estate information inputted by the user.

On the other hand, if the first determination means 26 and the second determination means 27 determine that the data center 110 should be provided at the real estate corresponding to the real estate information received by the reception means 22 (“YES” in STEP3 and “YES” in STEP5 in FIG. 4), the control unit 20 outputs information for recommending that the data center 110 should be provided. The outputted information is transmitted to the user terminal 50 or displayed on the display unit 34. Thus, a user can recognize that it is recommended that the data center 110 should be provided at the real estate corresponding to the real estate information inputted by the user.

If there are a plurality of categories in which the profitability in a case of providing the data center 110 is equal to or greater than the predetermined threshold, the category determination means 30 determines which category is appropriate, based on information on the profitability or information on both of the profitability and the safety rate for each category calculated by the calculation means 28 (STEP7 in FIG. 4). Specifically, the category determination means 30 determines that the category in which the profitability is greatest is an appropriate category, for example. Alternatively, the category determination means 30 determines that the category in which the profitability is greatest among categories in which at least the safety rate is greater than a predetermined threshold is an appropriate category. In determining which category is appropriate, the category determination means 30 may consider information on a building site condition, the building age, and the like based on the position of the building included in the real estate information received by the reception means 22. Specifically, the category determination means 30 calculates a score, based on the profitability or the profitability and the safety rate for each category calculated by the calculation means 28, and determines that the category with the highest score is an appropriate category. At this time, for example, in a case where the position of the building at which the new data center 110 is provided is in any of the 23 wards in Tokyo, the score may be made different from the other cases. In addition, in a case where the building age is greater than a predetermined number of years, the score may be made lower than in the other cases.

The control unit 20 outputs the determination result of the category determination means 30 (STEP8 in FIG. 4). The outputted determination result is transmitted to the user terminal 50 or displayed on the display unit 34 (STEP9 in FIG. 4). Thus, a user can recognize in which category (new construction/renovation and high specification/low specification) the data center 110 should be provided at the real estate corresponding to the real estate information inputted by the user.

Thereafter, if the user inputs information to actually provide the data center 110 for which the first determination means 26 and the second determination means 27 determine that the data center 110 should be provided at the real estate corresponding to the real estate information received by the reception means 22, to the user terminal 50 or by the operation unit 36 of the computer 10, the inputted information is transmitted from the user terminal 50 to the computer 10, whereby the reception means 22 receives information indicating that the data center 110 is to be provided (“YES” in STEP10 in FIG. 4). In this case, the storage means 24 stores information on the data center 110 to be provided, in the storage unit 40 or the external database 60 (STEP11 in FIG. 4). Thus, in a case of newly providing another data center 110 next time, information on the data center 110 to be provided this time can be reflected when the calculation means 28 calculates the safety rate of the data storage system 100.

In the present embodiment, the profitability for each category calculated by the calculation means 28 may be influenced by information on the already provided data center 110. For example, when the calculation means 28 calculates the profitability, in a case of providing the new data center 110 near the already provided data center 110, the management cost for each data center 110 can be lowered. Therefore, in such a case, by the storage means 24 storing the information on the data center 110 to be provided this time in the storage unit 40 or the external database 60, the information on the data center 110 to be provided this time can be reflected when the calculation means 28 calculates the profitability for the data storage system 100 in a case of newly providing another data center 110 next time.

According to the program, the computer 10, and the information processing method of the present embodiment configured as described above, the program causes the computer 10 to function as the reception means 22, the storage means 24, and the first determination means 26. The reception means 22 receives real estate information which is information on real estate as a candidate at which a data center 110 should be provided in the data storage system 100 composed of a plurality of data centers 110 coordinated with each other. The storage means 24 stores determination criterion information serving as a determination criterion for provision of the data center 110, in the storage unit 40 or the external database 60 in advance. The first determination means 26 determines whether or not the data center 110 should be provided at the real estate corresponding to the real estate information received by the reception means 22, based on the real estate information received by the reception means 22 and the determination criterion information stored in the storage unit 40 or the external database 60 in advance by the storage means 24. Thus, in a case of newly providing the data center 110 for composing the data storage system 100, it is possible to determine whether or not such provision of the data center 110 is appropriate.

In the program, the computer 10, and the information processing method of the present embodiment, as described above, the program further causes the computer 10 to function as the second determination means 27 and the calculation means 28. The calculation means 28 calculates the profitability in a case of providing the data center 110 at the real estate. The second determination means 27 determines whether or not the data center 110 should be provided at the real estate corresponding to the real estate information received by the reception means 22, based on the profitability. Thus, in a case of newly providing the data center 110 for composing the data storage system 100, it is possible to determine whether or not provision of the data center 110 is appropriate, based on the profitability in a case of providing the data center 110.

In the program, the computer 10, and the information processing method of the present embodiment, as described above, the calculation means 28 calculates the profitability for each of categories in which a condition that the building at which the data center 110 is to be provided is newly constructed or renovated and the specification level of the data center 110 are combined, based on the real estate information received by the reception means 22, and the second determination means 27 determines, for each category, whether or not the data center 110 should be provided at the real estate corresponding to the real estate information received by the reception means 22. Thus, in a case of newly providing the data center 110 for composing the data storage system 100, it is possible to determine whether or not provision of the data center 110 is appropriate, based on the profitability for each category. As another configuration, the calculation means 28 may calculate the profitability for each of categories regarding whether the building at which the data center 110 is to be provided is newly constructed or renovated, instead of each of categories in which a condition that the building at which the data center 110 is to be provided is newly constructed or renovated and the specification level of the data center 110 are combined. As still another configuration, the calculation means 28 may calculate the profitability for each specification level of the data center 110.

In the program, the computer 10, and the information processing method of the present embodiment, as described above, the program further causes the computer 10 to function as the category determination means 30, and the category determination means 30 determines which category is appropriate, based on the profitability for each category calculated by the calculation means 28. In this case, a user can recognize in which category the data center 110 should be provided.

In the program, the computer 10, and the information processing method of the present embodiment, as described above, the program further causes the computer 10 to function as the calculation means 28, the storage means 24 stores information on the data center 110 already provided in the data storage system 100, in the storage unit 40 or the external database 60 in advance, and the calculation means 28 calculates the safety rate of the data storage system 100 in a case of providing the data center 110 at the real estate, based on the real estate information received by the reception means 22 and the information on the data center 110 stored in the storage unit 40 or the external database 60 in advance by the storage means 24. In this case, by using the information on the already provided data center 110, it is possible to accurately calculate the safety rate of the data storage system 100 in a case of newly providing the data center 110.

The program further causes the computer 10 to function as the second determination means 27, the calculation means 28 calculates the profitability in a case of providing the data center 110 at the real estate, and the second determination means 27 determines whether or not the data center 110 should be provided at the real estate corresponding to the real estate information received by the reception means 22, based on the profitability and the safety rate calculated by the calculation means 28. In this case, since the safety rate of the data storage system 100 in a case of providing the data center 110 is also considered, it is possible to more accurately determine whether or not the data center 110 should be provided.

The calculation means 28 calculates the profitability and the safety rate for each of categories in which the condition that the building at which the data center 110 is to be provided is newly constructed or renovated and the specification level of the data center 110 are combined, based on the real estate information received by the reception means 22, and the second determination means 27 determines, for each category, whether or not the data center 110 should be provided at the real estate corresponding to the real estate information received by the reception means 22. Thus, in a case of newly providing the data center 110 for composing the data storage system 100, it is possible to determine whether or not provision of the data center 110 is appropriate, based on the profitability and the safety rate for each category. As another configuration, the calculation means 28 may calculate the profitability and the safety rate for each of categories regarding whether the building at which the data center 110 is to be provided is newly constructed or renovated, instead of each of categories in which a condition that the building at which the data center 110 is to be provided is newly constructed or renovated and the specification level of the data center 110 are combined. As still another configuration, the calculation means 28 may calculate the profitability and the safety rate for each specification level of the data center 110.

In the program, the computer 10, and the information processing method of the present embodiment, as described above, the program further causes the computer 10 to function as the category determination means 30, and the category determination means 30 determines which category is appropriate, based on the profitability and the safety rate for each category calculated by the calculation means 28. In this case, a user can recognize in which category the data center 110 should be provided.

In the program, the computer 10, and the information processing method of the present embodiment, as described above, in a case where the first determination means 26 determines that the data center 110 should be provided at the real estate corresponding to the real estate information received by the reception means 22, if the reception means 22 receives information indicating that the data center 110 is to be provided at the real estate, the storage means 24 stores the information on the data center 110 in the storage unit 40. Thus, in a case of newly providing another data center 110 next time, information on the data center 110 to be provided this time can be reflected when the calculation means 28 calculates at least one of the profitability and the safety rate of the data storage system 100.

The program, the computer 10, the information processing method, and the like according to the present embodiment are not limited to the above configurations, and may be variously modified.

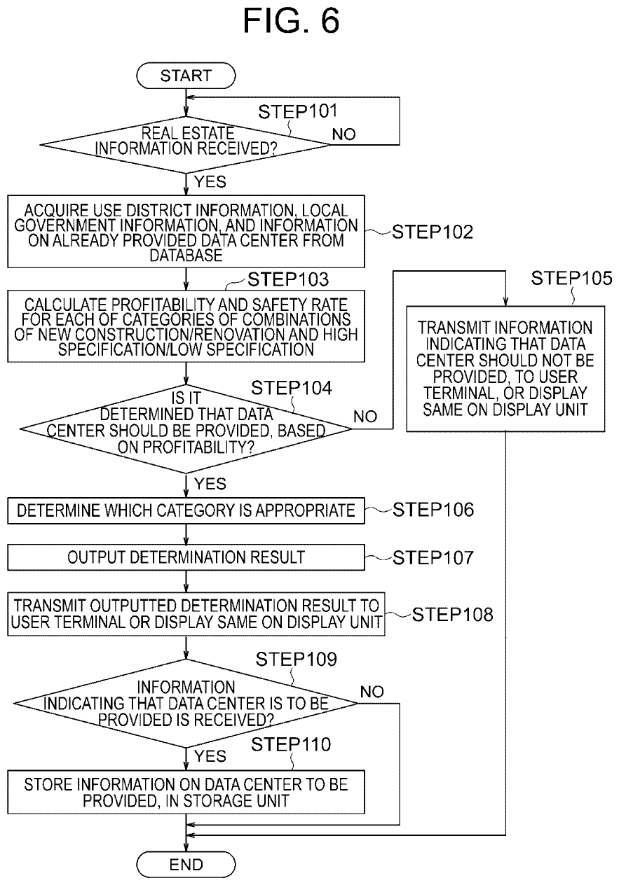

For example, without the first determination means 26 determining whether or not the data center 110 should be provided at the real estate corresponding to the real estate information received by the reception means 22 based on the determination criterion information, the calculation means 28 may calculate the profitability of the data storage system 100 in a case of providing the data center 110 at the real estate, based on the real estate information received by the reception means 22, and the second determination means 27 may determine whether or not the data center 110 should be provided, based on the calculated profitability. Such a configuration will be described with reference to a flowchart shown in FIG. 6.

In a case where a user desires to add a new data center 110 to the data storage system 100 composed of a plurality of already provided data centers 110, the user inputs the real estate information which is information on the real estate as a candidate at which the new data center 110 should be provided, through the user terminal 50. The real estate information inputted to the user terminal 50 is transmitted from the user terminal 50 to the computer 10. Thus, the reception means 22 receives the real estate information (“YES” in STEP101 in FIG. 6). The control unit 20 acquires the use district information, the local government information, and the information on the already provided data center 110 from the storage unit 40 or the external database 60 (STEP102 in FIG. 6). Alternatively, the control unit 20 reads the use district information, the local government information, and the information on the already provided data center 110 from the storage unit 40.

Next, the calculation means 28 calculates the profitability and the safety rate of the data storage system 100 in a case of providing the data center 110 in each of categories of combinations of new construction/renovation and high specification/low specification (STEP103 in FIG. 6). If the profitability in a case of providing the data center 110 is smaller than a predetermined threshold for all of the plurality of categories described above, the second determination means 27 determines that the data center 110 should not be provided at the real estate corresponding to the real estate information received by the reception means 22 (“NO” in STEP104 in FIG. 6). On the other hand, if the profitability in a case of providing the data center 110 is equal to or greater than the predetermined threshold for at least one of the plurality of categories described above, the second determination means 27 determines that the data center 110 should be provided at the real estate corresponding to the real estate information received by the reception means 22 (“YES” in STEP104 in FIG. 6).

If the second determination means 27 determines that the data center 110 should not be provided at the real estate corresponding to the real estate information received by the reception means 22 (“NO” in STEP104 in FIG. 6), the control unit 20 outputs information indicating that the data center 110 should not be provided. The outputted information is transmitted to the user terminal 50 or displayed on the display unit 34 (STEP105 in FIG. 6). On the other hand, if the second determination means 27 determines that the data center 110 should be provided at the real estate corresponding to the real estate information received by the reception means 22 (“YES” in STEP104 in FIG. 6), the control unit 20 outputs information indicating that the data center 110 should be provided. The outputted information is transmitted to the user terminal 50 or displayed on the display unit 34. Thus, a user can recognize that the data center 110 should be provided at the real estate corresponding to the real estate information inputted by the user.

If there are a plurality of categories in which the profitability in a case of providing the data center 110 is equal to or greater than the predetermined threshold, the category determination means 30 determines which category is appropriate, based on information on the profitability or information on both of the profitability and the safety rate for each category calculated by the calculation means 28 (STEP106 in FIG. 6). Then, the control unit 20 outputs the determination result of the category determination means 30 (STEP107 in FIG. 6). The outputted determination result is transmitted to the user terminal 50 or displayed on the display unit 34 (STEP108 in FIG. 6). Thus, a user can recognize in which category (new construction/renovation and high specification/low specification) the data center 110 should be provided at the real estate corresponding to the real estate information inputted by the user.

Thereafter, if the user inputs information to actually provide the data center 110 for which the second determination means 27 determines that the data center 110 should be provided at the real estate corresponding to the real estate information received by the reception means 22, to the user terminal 50 or by the operation unit 36 of the computer 10, the inputted information is transmitted from the user terminal 50 to the computer 10, whereby the reception means 22 receives information indicating that the data center 110 is to be provided (“YES” in STEP109 in FIG. 6). In this case, the storage means 24 stores information on the data center 110 to be provided, in the storage unit 40 or the external database 60 (STEP110 in FIG. 6). Thus, in a case of newly providing another data center 110 next time, information on the data center 110 to be provided this time can be reflected when the calculation means 28 calculates the safety rate of the data storage system 100.

According to the program, the computer 10, and the information processing method related to FIG. 6, the program causes the computer 10 to function as the reception means 22, the second determination means 27, and the storage means 24. The reception means 22 receives real estate information which is information on real estate as a candidate at which a data center 110 should be provided in the data storage system 100 composed of a plurality of data centers 110 coordinated with each other. The calculation means 28 calculates the profitability in a case of providing the data center 110 at the real estate, and the second determination means 27 determines whether or not the data center 110 should be provided at the real estate corresponding to the real estate information received by the reception means 22, based on the calculated profitability. Thus, in a case of newly providing the data center 110 for composing the data storage system 100, it is possible to determine whether or not such provision of the data center 110 is appropriate.

The high-specification data center 110 and the low-specification data center 110 are not limited to the configurations shown in FIG. 2. The high-specification data center 110 and the low-specification data center 110 may have configurations other than those shown in FIG. 2. The specification levels of the data centers 110 are not limited to two levels of the high-specification data center 110 and the low-specification data center 110. The specification levels of the data centers 110 may include three or more levels.

As still another configuration, even in a case where neither the first determination means 26 nor the second determination means 27 determines whether or not the data center 110 should be provided at the real estate corresponding to the real estate information received by the reception means 22, the calculation means 28 may calculate the profitability for each category of at least any of categories in which a condition that the building at which the data center 110 is to be provided is newly constructed or renovated and the specification level of the data center 110 are combined, based on the real estate information received by the reception means 22. In this case, the category determination means 30 may determine which category is appropriate, based on the profitability for each category calculated by the calculation means 28. Thus, a user can recognize in which category the data center 110 should be provided.

1. An information processing method performed by a computer executing a program, the method comprising:
receiving real estate information which is information on real estate as a candidate at which a data center should be provided in a data storage system composed of a plurality of data centers coordinated with each other;
storing determination criterion information serving as a determination criterion for provision of the data center, in a storage unit in advance; and
determining whether or not the data center should be provided at the real estate corresponding to the received real estate information, based on the received real estate information and the determination criterion information stored in the storage unit in advance.

2. The information processing method according to claim 1, comprising calculating a profitability in a case of providing the data center at the real estate, wherein
in determining whether or not the data center should be provided at the real estate corresponding to the received real estate information, whether or not the data center should be provided at the real estate corresponding to the received real estate information is determined based on the profitability.

3. The information processing method according to claim 2, wherein
in determining whether or not the data center should be provided at the real estate corresponding to the received real estate information, the profitability is calculated, based on the received real estate information, for each category of at least any of a category regarding whether a building at which the data center is to be provided is newly constructed or renovated, a category of a specification level of the data center, or a category in which whether the building at which the data center is to be provided is newly constructed or renovated and the specification level of the data center are combined, and whether or not the data center should be provided at the real estate corresponding to the received real estate information is determined for each category.

4. The information processing method according to claim 3, wherein
if the profitability in the case of providing the data center is smaller than a predetermined threshold for all of a plurality of the categories, it is determined that the data center should not be provided at the real estate corresponding to the received real estate information, and
if the profitability in the case of providing the data center is equal to or greater than the predetermined threshold for at least one of the plurality of categories, it is determined that the data center should be provided at the real estate corresponding to the received real estate information.

5. The information processing method according to claim 3, comprising determining which category is appropriate, based on the calculated profitability for each category.

6. The information processing method according to claim 1, comprising:
storing information on the data center already provided in the data storage system, in the storage unit in advance; and
calculating a safety rate of the data storage system in a case of providing the data center at the real estate, based on the received real estate information and the information on the data center stored in the storage unit in advance.

7. The information processing method according to claim 6, comprising calculating a profitability in the case of providing the data center at the real estate, wherein
in determining whether or not the data center should be provided at the real estate corresponding to the received real estate information, whether or not the data center should be provided at the real estate corresponding to the received real estate information is determined based on the calculated profitability and the calculated safety rate.

8. The information processing method according to claim 7, comprising:
calculating the profitability and the safety rate, based on the received real estate information, for each category of at least any of a category regarding whether a building at which the data center is to be provided is newly constructed or renovated, a category of a specification level of the data center, or a category in which whether the building at which the data center is to be provided is newly constructed or renovated and the specification level of the data center are combined; and
determining whether or not the data center should be provided at the real estate corresponding to the received real estate information, for each category.

9. The information processing method according to claim 8, comprising determining which category is appropriate, based on the calculated profitability and the calculated safety rate for each category.

10. The information processing method according to claim 1, wherein
in a case where it is determined that the data center should be provided at the real estate corresponding to the received real estate information, if information indicating that the data center is to be provided at the real estate is received, information on the data center is stored in the storage unit.

11. An information processing method performed by a computer executing a program, the method comprising:
receiving real estate information which is information on real estate as a candidate at which a data center should be provided in a data storage system composed of a plurality of data centers coordinated with each other;
calculating a profitability of the data storage system in a case of providing the data center at the real estate; and
determining whether or not the data center should be provided at the real estate corresponding to the real estate information, based on the calculated profitability.

12. A computer configured to, by executing a program:
receive real estate information which is information on real estate as a candidate at which a data center should be provided in a data storage system composed of a plurality of data centers coordinated with each other;
store determination criterion information serving as a determination criterion for provision of the data center, in a storage unit in advance; and
determine whether or not the data center should be provided at the real estate corresponding to the received real estate information, based on the received real estate information and the determination criterion information stored in the storage unit in advance.

13. The computer according to claim 12, configured to, by executing the program, calculate a profitability in a case of providing the data center at the real estate, wherein
in determining whether or not the data center should be provided at the real estate corresponding to the received real estate information, whether or not the data center should be provided at the real estate corresponding to the received real estate information is determined based on the profitability.

14. The computer according to claim 13, wherein
in determining whether or not the data center should be provided at the real estate corresponding to the received real estate information, the profitability is calculated, based on the received real estate information, for each category of at least any of a category regarding whether a building at which the data center is to be provided is newly constructed or renovated, a category of a specification level of the data center, or a category in which whether the building at which the data center is to be provided is newly constructed or renovated and the specification level of the data center are combined, and whether or not the data center should be provided at the real estate corresponding to the received real estate information is determined for each category.

15. The computer according to claim 14, configured to, by executing the program, determine which category is appropriate, based on the calculated profitability for each category.

16. The computer according to claim 12, configured to, by executing the program:
store information on the data center already provided in the data storage system, in the storage unit in advance; and
calculate a safety rate of the data storage system in a case of providing the data center at the real estate, based on the received real estate information and the information on the data center stored in the storage unit in advance.

17. The computer according to claim 16, configured to, by executing the program, calculate a profitability in the case of providing the data center at the real estate, wherein
in determining whether or not the data center should be provided at the real estate corresponding to the received real estate information, whether or not the data center should be provided at the real estate corresponding to the received real estate information is determined based on the calculated profitability and the calculated safety rate.

18. The computer according to claim 17, configured to, by executing the program:
calculate the profitability and the safety rate, based on the received real estate information, for each category of at least any of a category regarding whether a building at which the data center is to be provided is newly constructed or renovated, a category of a specification level of the data center, or a category in which whether the building at which the data center is to be provided is newly constructed or renovated and the specification level of the data center are combined; and
determine whether or not the data center should be provided at the real estate corresponding to the received real estate information, for each category.

19. The computer according to claim 18, configured to, by executing the program, determine which category is appropriate, based on the calculated profitability and the calculated safety rate for each category.

20. The computer according to claim 12, wherein
in a case where it is determined that the data center should be provided at the real estate corresponding to the received real estate information, if information indicating that the data center is to be provided at the real estate is received, information on the data center is stored in the storage unit.
